(19) United States
(12) Patent Application Publication
(10) Pub. No.: US 2014/0361066 A1
(43) Pub. Date: Dec. 11, 2014

(54) NAIL MAGAZINE FOR A POWER NAIL-DRIVING TOOL

(71) Applicant: BASSO INDUSTRY CORP., Taichung (TW)

(72) Inventors: An-Gi Liu, Taichung (TW); Yuan-Chi Chiang, Taichung (TW)

(73) Assignee: BASSO INDUSTRY CORP., Taichung (TW)

(21) Appl. No.: 14/294,959

(22) Filed: Jun. 3, 2014

(30) Foreign Application Priority Data
Jun. 5, 2013 (TW) 102210568

(51) Int. Cl. B25C 5/16; B25C 1/00

(52) U.S. Cl. CPC B25C 5/1617; B25C 1/005; B25C 5/1665
USPC 227/119

(57) ABSTRACT

A nail magazine for a power nail-driving tool includes an elongated magazine unit and a leaf spring unit which includes an elongated body and first and second guiding members. The elongated body has a rearward end fixed to the elongated magazine, and a forward end which is movable between a blocking position and a yielded position. The first guiding member has a barrier shoulder configured to block loading movement of a nail strip when the nail strip is loaded in a wrong orientation. The second guiding member has a ramp-up region configured to permit the nail strip to depress the forward end to the yielded position when the nail strip is loaded in a correct orientation.

### CROSS-REFERENCE TO RELATED APPLICATION

This application claims priority of Taiwanese application no. 102210568, filed on Jun. 5, 2013.

### BACKGROUND OF THE INVENTION

1. Field of the Invention

This invention relates to a nail magazine, more particularly to a nail magazine for a power nail-driving tool which can prevent a nail strip from being loaded into the nail magazine in an erroneous orientation.

2. Description of the Related Art

With reference to FIGS. 1 and 2, US patent application publication no. 20120248168 discloses a nail magazine 1 for a driving tool. The nail magazine 1 includes a magazine housing 11, a restricting member 12, and a stop member 14. The magazine housing 11 is configured to permit a nail strip 13 to be loaded therein. The restricting member 12 and the stop member 14 extend opposite to each other and are fixed to a bottom wall 111 of the magazine housing 11. The stop member 14 serves to prevent the nail strip 13 from moving rearwardly opposite to a loading direction (S). The restricting member 12 includes an arm portion 121, a broad width portion 121a, and a guided portion 123. The broad width portion 121a has a restricting portion 122.

When the nail strip 13 as shown in FIG. 1 is loaded into the magazine housing 11 in a correct orientation, the nail strip 13 will be guided by the guided portion 123 to slip over the restricting member 12 and then over the stop member 14 toward a nose (not shown) of the driving tool.

When the nail strip 13 as shown in FIG. 2 is loaded into the magazine housing 11 in a wrong orientation, the nail strip 13 will be blocked by the restricting portion 122.

### SUMMARY OF THE INVENTION

An object of the present invention is to provide a novel nail magazine for a power nail-driving tool. The nail magazine includes an elongated magazine unit and a leaf spring unit. A nail strip loaded in a wrong orientation can be blocked by the leaf spring unit and can thus be prevented from being loaded into the nail magazine. A nail strip loaded in a correct orientation can slip over the leaf spring unit and be loaded into the nail magazine.

According to one aspect of the present invention, a nail magazine for a power nail-driving tool of the present invention is provided. The power nail-driving tool includes a nose defining a striking path extending along a striking axis. The nail magazine includes an elongated magazine unit and a leaf spring unit. The elongated magazine unit is adapted to be mounted to the nose, and adapted for lading therein a nail strip including a plurality of nails. The elongated magazine unit includes a bottom wall extending in a front-to-rear direction to terminate at a rear end edge and a front discharging marginal edge which is configured to permit discharging of a leading one of the nails into the striking path. The elongated magazine unit defines a nail channel which is disposed over the bottom wall and between the front discharging marginal edge and the rear end edge to define a loading route, and which is configured to permit loading movement of the nail strip along the loading route when the nail strip is loaded into the elongated magazine unit. The leaf spring unit includes an elongated body and first and second guiding members. The elongated body extends in the front-to-rear direction to terminate at a rearward end fixed to the bottom wall proximate to the rear end edge, and a forward end which is biased to a blocking position, where the nails are prevented from slipping over the forward end, and which is movable to a yielded position, where the forward end is depressed by the nails against a biasing action of the elongated body to permit the loading movement of the nails toward the nose. The first guiding member includes a cut-out segment and a first guiding segment which extends upwardly from the elongated body adjacent to the forward end to terminate at a first guiding region. The cut-out segment and the first guiding segment cooperatively define a barrier shoulder therebetween. The barrier shoulder is configured to stand in the loading route to block the loading movement of the nail strip when the nail strip is loaded in a wrong orientation. The second guiding member includes a ramp-up segment and a second guiding segment which extends upwardly from the elongated body adjacent to the forward end to terminate at a second guiding region, and which is spaced apart from the first guiding member in a direction of the striking axis. The ramp-up segment has a ramp-up region configured to permit the nail strip to advance to the first and second guiding regions to thereby depress the forward end to the yielded position when the nail strip is loaded in a correct orientation.

According to another aspect of the present invention, a nail magazine for a power nail-driving tool is provided. The power nail-driving tool includes a nose defining a striking path extending along a striking axis. The nail magazine includes a magazine unit and a yieldable unit. The magazine unit is adapted to be mounted to the nose, and is adapted for lading therein a nail strip including a plurality of nails. The magazine unit includes a bottom wall extending in a front-to-rear direction to terminate at a rear end edge and a front discharging marginal edge which is configured to permit discharging of a leading one of the nails into the striking path. The magazine unit defines a nail channel which is disposed over the bottom wall and between the front discharging marginal edge and the rear end edge to define a loading route, and which is configured to permit loading movement of the nail strip along the loading route when the nail strip is loaded into the magazine unit. The yieldable unit includes a main body and first and second guiding members. The main body extends in the front-to-rear direction to terminate at rearward and forward ends, and is disposed to permit the forward end to be urged by a biasing action, to a blocking position, where the nails are prevented from slipping over the forward end. The forward end is depressible against the biasing action to a yielded position to permit the loading movement of the nails toward the nose. The first guiding member includes a cut-out segment and a first guiding segment which extends upwardly from the main body adjacent to the forward end to terminate at a first guiding region. The cut-out segment and the first guiding segment cooperatively define a barrier shoulder therebetween. The barrier shoulder is configured to stand in the loading route to block the loading movement of the nail strip when the nail strip is loaded in a wrong orientation. The second guiding member includes a ramp-up segment and a second guiding segment which extends upwardly from the elongated body adjacent to the forward end to terminate at a second guiding region, and which is spaced apart from the first guiding member in a direction of the striking axis. The ramp-up segment has a ramp-up region configured to permit the nail strip to advance to the first and second guiding regions to thereby depress the forward end to the yielded position when the nail strip is loaded in a correct orientation.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a fragmentary side view of a conventional nail magazine showing a nail strip loaded in a correct orientation;

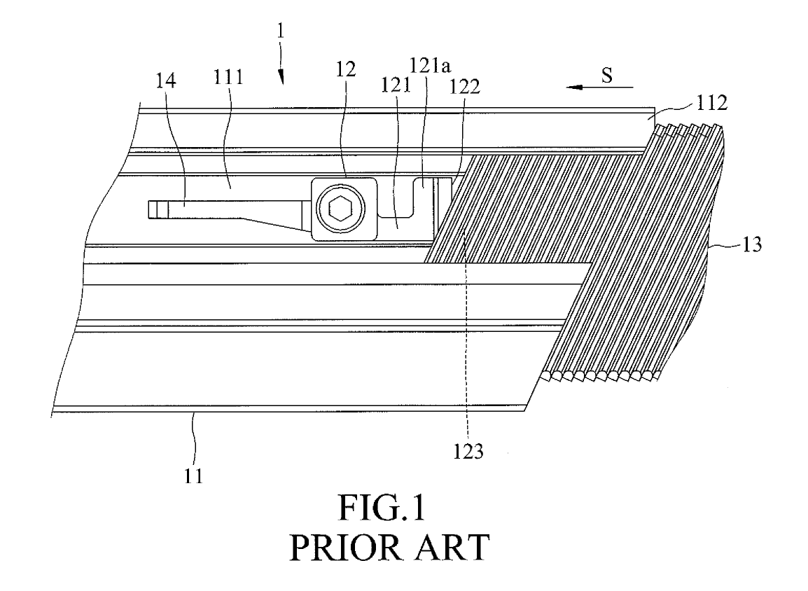

FIG. 2 is similar to FIG. 1 but showing the nail strip loaded in a wrong orientation;

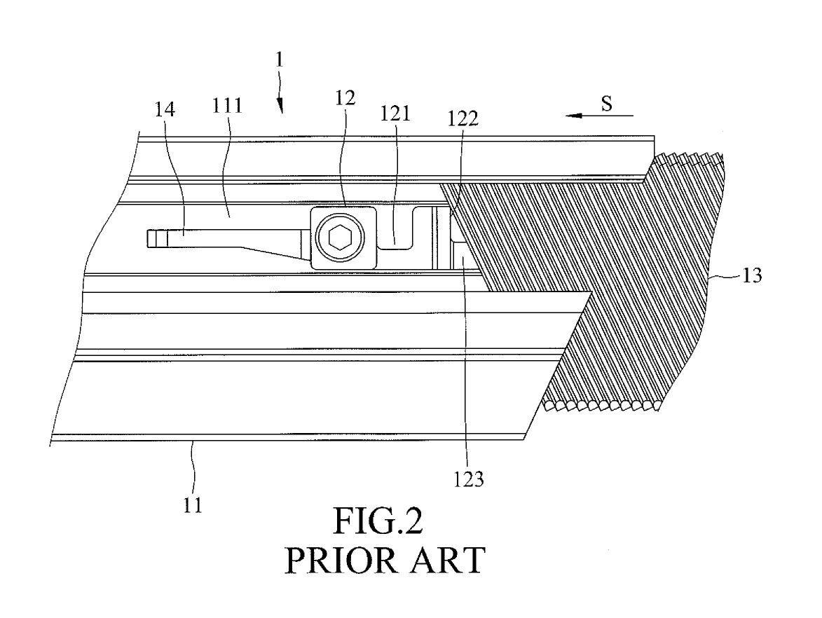

FIG. 3 is a perspective view of a power nail-driving tool which includes a nail magazine according to a preferred embodiment of this invention;

FIG. 4 is a perspective view of a leaf spring unit of the nail magazine according to the preferred embodiment of this invention;

FIG. 5 is a perspective view of the nail magazine showing a nail strip loaded in a wrong orientation;

FIG. 6 is a fragmentary cross-sectional view taken along line VI-VI of FIG. 5;

FIG. 7 is similar to FIG. 5 but showing the nail strip loaded in a correct orientation; and

FIG. 8 is a fragmentary cross-sectional view taken along line VIII-VIII of FIG. 7.

### DETAILED DESCRIPTION OF THE PREFERRED EMBODIMENT

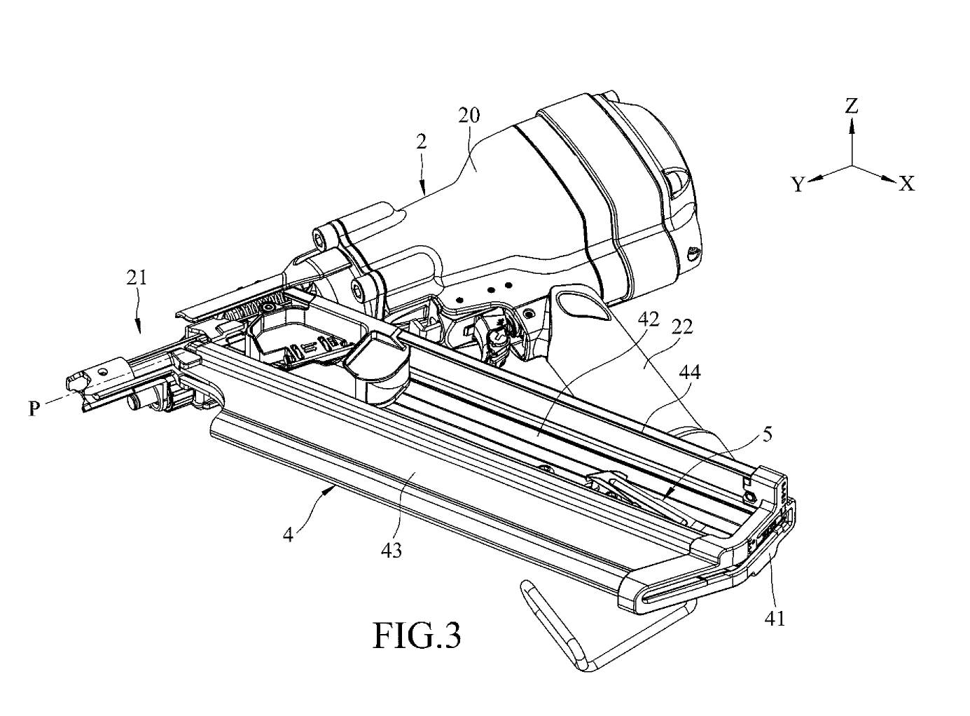

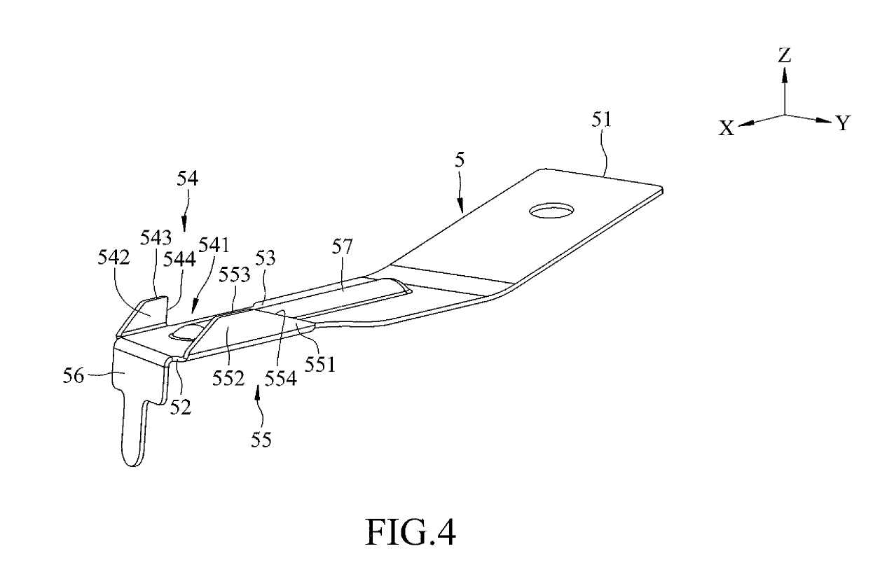

FIGS. 3 to 8 show a preferred embodiment of a nail magazine for a power nail-driving tool 2 according to this invention. The power nail-driving tool 2 includes a drive portion 20, a nose 21 and a handle 22. The nose 21 defines a striking path (P) extending along a striking axis. The drive portion 20 includes a driver (not shown) and other components for generating a force for driving a leading one of nails 30 into a work piece (not shown) along the striking path (P). The nails 30 are temporarily connected to each other in the form of a nail strip 3, and each of the nails 30 extends lengthwise to terminate at a nail head 31 and a tip end 32.

The nail magazine includes an elongated magazine unit 4 and a leaf spring unit 5.

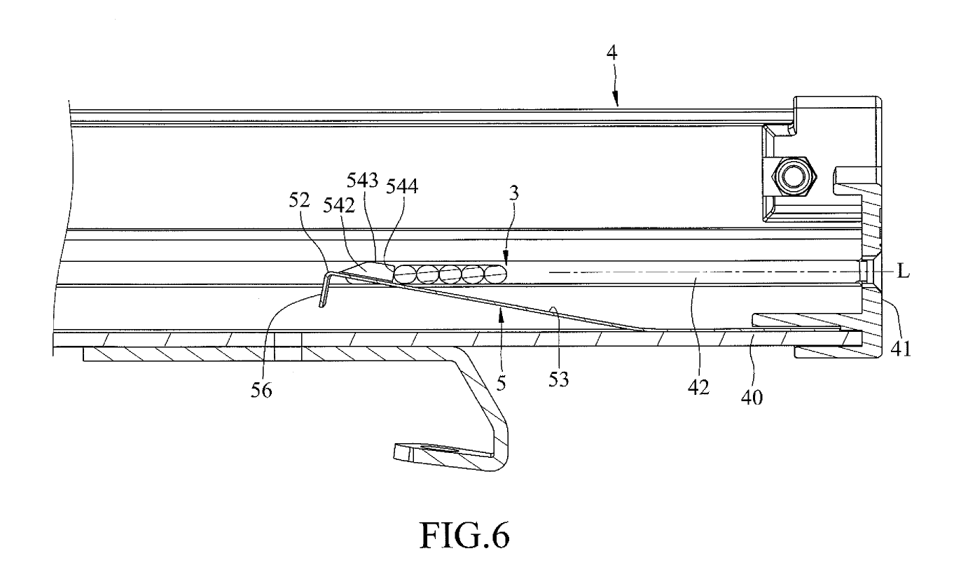

The elongated magazine unit 4 is adapted to be mounted to the nose 21 and for loading of the nail strip 3 therein. The elongated magazine unit 4 includes a bottom wall 40 (see FIG. 6) which extends in a front-to-rear direction (X) to terminate at a rear end edge 41 and a front discharging marginal edge 45 that is configured to permit discharging of the leading one of the nails 30 into the striking path (P). The elongated magazine unit 4 defines a nail channel 42 which is disposed over the bottom wall 40 and between the front discharging marginal edge 45 and the rear end edge 41 to define a loading route (L), and which is configured to permit loading movement of the nail strip 3 along the loading route (L) when the nail strip 3 is loaded into the elongated magazine unit 4.

In this embodiment, the elongated magazine unit 4 further includes left and right frames 43, 44 which are spaced apart from each other in a direction (Y) of the striking axis, and which extend from the bottom wall 4 upwardly in an upright direction (Z) to respectively define left and right guideways 431, 441. The left and right guideways 431, 441 cooperatively define the nail channel 42 therebetween. The nail heads 31 of the nails 30 are guided by the right guideways 441, and the tip ends 32 of the nails 30 are guided by the left guideway 431. Preferably, each of the left and right guideways 431, 441 is a guiding groove.

The leaf spring unit 5 is a yieldable unit, and includes an elongated body (main body) 53 and first and second guiding members 54, 55.

The elongated body 53 extends in the front-to-rear direction (X) to terminate at a rearward end 51 and a forward end 52. The rearward end 51 is fixed to the bottom wall 40 proximate to the rear end edge 41. The forward end 52 is biased to a blocking position, where the nails 30 are prevented from slipping over the forward end 52, and is movable to a yielded position, where the forward end 52 is depressed by the nails 30 against a biasing action of the elongated body 53 to permit the loading movement of the nails 30 toward the nose 21.

In other preferred embodiment, the rearward end 51 may not fixed to the bottom wall 40. For example, the elongated body (main body) 53 is disposed to permit the forward end 52 to be urged, by a biasing action, to a blocking position, where the nails 30 are prevented from slipping over the forward end 52. The forward end 52 is depressible against the biasing action to a yielded position to permit the loading movement of the nails 30 toward the nose 21.

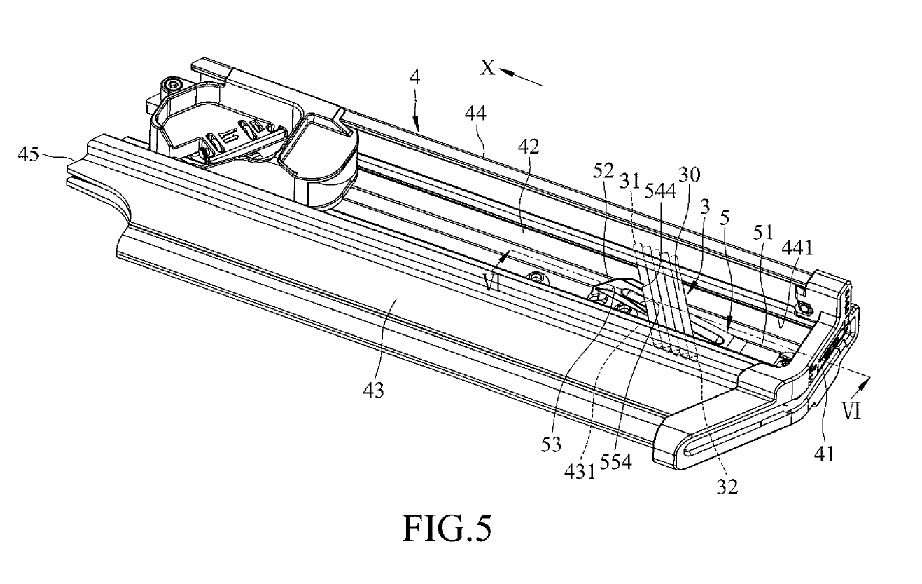

The first guiding member 54 includes a cut-out segment 541 and a first guiding segment 542. The first guiding segment 542 extends upwardly from the elongated body 53 adjacent to the forward end 52 to terminate at a first guiding region 543. The cut-out segment 541 and the first guiding segment 542 cooperatively define a barrier shoulder 544 therebetween. The barrier shoulder 544 is configured to stand in the loading route (L) to block the loading movement of the nail strip 3 when the nail strip 3 is loaded in a wrong orientation, i.e., the nail head 31 of each of the nails 30 is positioned forwardly of the tip end 32, as shown in FIGS. 5 and 6.

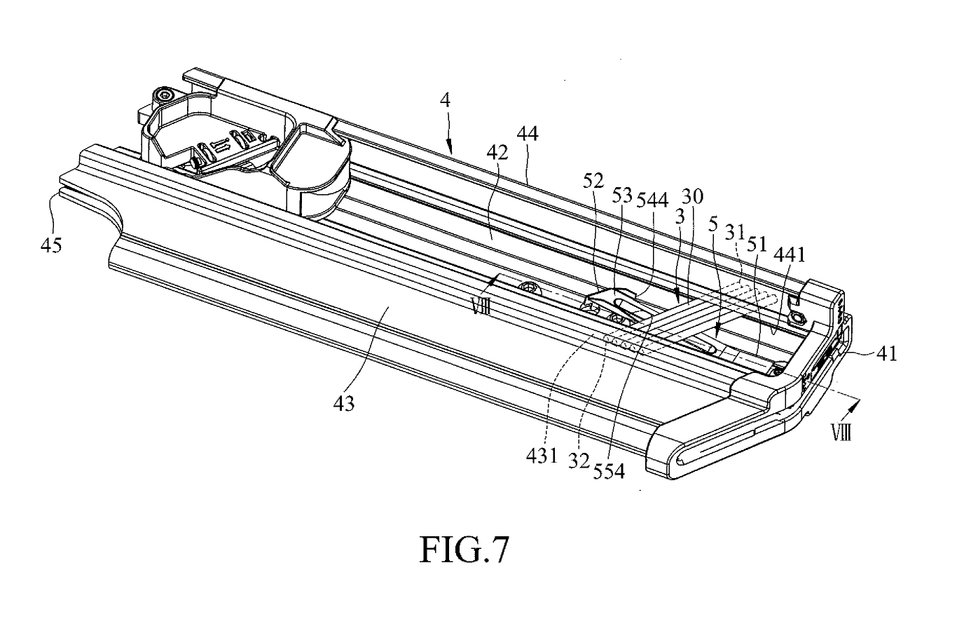

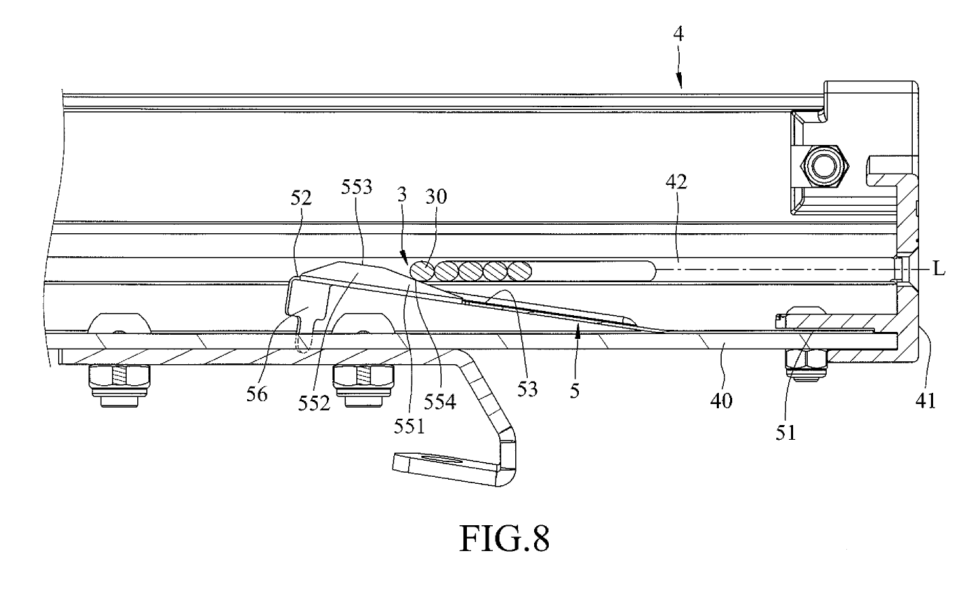

The second guiding member 55 includes a ramp-up segment 551 and a second guiding segment 552. The second guiding segment 552 extends upwardly from the elongated body 53 adjacent to the forward end 52 to terminate at a second guiding region 553, and is spaced apart from the first guiding member 54 in the direction (Y) of the striking axis. The ramp-up segment 551 has a ramp-up region 554 configured to permit the nail strip 3 to advance to the first and second guiding regions 543, 553 to thereby depress the forward end 52 to the yielded position when the nail strip 3 is loaded in a correct orientation, i.e., the nail head 31 of each of the nails 30 is positioned rearwardly of the tip end 32, as shown in FIGS. 7 and 8.

In this embodiment, the ramp-up region 554 extends to and is connected to the second guiding region 553. The first guiding member 54 is disposed proximate to the nail heads 31 of the nails 30, and the second guiding member 55 is disposed distal from the nail heads 31 of the nails 30. The ramp-up region 554 is disposed rearwardly of the first guiding segment 542 and the barrier shoulder 544.

Preferably, the leaf spring unit 5 further includes a retaining tab 56 extending downward from the forward end 52 toward the bottom wall 40 such that once a trailing one of the nails 30 of the nail strip 3 slips over the forward end 52, the nail strip 3 is urged by the retaining tab 56.

Preferably, the elongated body 53 is dented upward to form a ridge portion 57 so as to increase the structural rigidity of the elongated body 53.

Preferably, the elements of the leaf spring unit 5 are formed in one-piece.

With the provision of the leaf spring unit 5 in the elongated magazine unit 4, the nail strip 3 can be prevented from being loaded into the nail magazine of this invention in a wrong orientation.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A nail magazine for a power nail-driving tool which includes a nose defining a striking path extending along a striking axis, said nail magazine comprising:
an elongated magazine unit adapted to be mounted to the nose, and adapted for lading therein a nail strip including a plurality of nails, said elongated magazine unit including a bottom wall extending in a front-to-rear direction to terminate at a rear end edge and a front discharging marginal edge which is configured to permit discharging of a leading one of the nails into the striking path, said elongated magazine unit defining a nail channel which is disposed over said bottom wall and between said front discharging marginal edge and said rear end edge to define a loading route, and which is configured to permit loading movement of the nail strip along the loading route when the nail strip is loaded into said elongated magazine unit; and
a leaf spring unit including
an elongated body extending in the front-to-rear direction to terminate at a forward end and a rearward end which is fixed to said bottom wall proximate to said rear end edge,
a first guiding member including a cut-out segment and a first guiding segment which extends upwardly from said elongated body adjacent to said forward end to terminate at a first guiding region, said cut-out segment and said first guiding segment cooperatively defining a barrier shoulder therebetween, and
a second guiding member including a ramp-up segment and a second guiding segment which extends upwardly from said elongated body adjacent to said forward end to terminate at a second guiding region that is spaced apart from said first guiding region in a direction of the striking axis, said ramp-up segment having a ramp-up region,
wherein when the nail strip is loaded in a wrong orientation, said forward end is biased to a blocking position such that said barrier shoulder stands in the loading route to block the loading movement of the nail strip; and
wherein when the nail strip is loaded in a correct orientation, the nail strip is permitted to be guided by said ramp-up region to advance to said first and second guiding regions to thereby depress said forward end to a yielded position and to thereby permit the loading movement of the nails toward the nose.

2. The nail magazine of claim 1, wherein said ramp-up region extends to and is connected to said second guiding region.

3. The nail magazine of claim 1, wherein said leaf spring unit further includes a retaining tab extending downward from said forward end toward said bottom wall such that once a trailing one of the nails of the nail strip slips over said forward end, the nail strip is urged by said retaining tab.

4. The nail magazine of claim 1, wherein said elongated body is dented upward to form a ridge portion so as to increase structural rigidity of said elongated body.

5. The nail magazine of claim 1, wherein said elongated magazine unit further includes left and right frames which are spaced apart from each other in the direction of the striking axis, and which extend upwardly from said bottom wall in an upright direction to define left and right guideways, respectively, said left and right guideways cooperatively defining said nail channel therebetween.

6. The nail magazine of claim 5, wherein each of said left and right guideways is a guiding groove.

7. A nail magazine for a power nail-driving tool which includes a nose defining a striking path extending along a striking axis, said nail magazine comprising:
a magazine unit adapted to be mounted to the nose, and adapted for lading therein a nail strip including a plurality of nails, said magazine unit including a bottom wall extending in a front-to-rear direction to terminate at a rear end edge and a front discharging marginal edge which is configured to permit discharging of a leading one of the nails into the striking path, said magazine unit defining a nail channel which is disposed over said bottom wall and between said front discharging marginal edge and said rear end edge to define a loading route, and which is configured to permit loading movement of the nail strip along the loading route when the nail strip is loaded into said magazine unit; and
a yieldable unit including
a main body which extends in the front-to-rear direction to terminate at rearward and forward ends,
a first guiding member including a cut-out segment and a first guiding segment which extends upwardly from said main body adjacent to said forward end to terminate at a first guiding region, said cut-out segment and said first guiding segment cooperatively defining a barrier shoulder therebetween, and
a second guiding member including a ramp-up segment and a second guiding segment which extends upwardly from said elongated body adjacent to said forward end to terminate at a second guiding region that is spaced apart from said first guiding region in a direction of the striking axis, said ramp-up segment having a ramp-up region,
wherein the nail strip is loaded in a wrong orientation, said forward end is biased to a blocking position such that said barrier shoulder stands in the loading route to block the loading movement of the nail strip; and
wherein when the nail strip is loaded in a correct orientation, the nail strip is permitted to be guided by said ramp-up region to advance to said first and second guiding regions to thereby depress said forward end to a yielded position and to thereby permit the loading movement of the nails toward the nose.
